(19) United States
(12) Patent Application Publication
(10) Pub. No.: US 2009/0199586 A1
(43) Pub. Date: Aug. 13, 2009

(54) COOLING DEVICE

(76) Inventors: F. Alper Soysal, Istanbul (TR); A. Kerem Kurt, Istanbul (TR)

Correspondence Address: VENABLE, CAMPILLO, LOGAN & MEANEY, P.C., 1938 E. OSBORN RD, PHOENIX, AZ, 85016-7234, US

(21) Appl. No.: 12/302,884

(22) PCT Filed: Jun. 8, 2007
(86) PCT No.: PCT/EP2007/055635

§ 371 Date: Nov. 29, 2008

(30) Foreign Application Priority Data
Jun. 9, 2006 (TR) 2006/02947

(51) Int. Cl. B67D 5/62; F25B 1/00; F25D 23/00

(52) U.S. Cl. 62/389; 62/498; 62/449

(57) ABSTRACT

The cooling device (1) of the present invention comprises a cooling cabin (2) wherein items to be cooled are stored, one or more doors (3), preventing heat transfer between the cooling cabin (2) and the exterior environment when closed, providing access for the user to the cooling cabin (2) when opened, a compressor (7) providing the refrigerant to be sucked and pumped, a condenser (8) condensing the refrigerant leaving the compressor as superheated vapor to first liquid vapor phase then to entirely liquid phase, a water reservoir (5) disposed on the door (3) or the cabin (2) wherein water is stored, and a water dispenser (4) providing the water in the water reservoir (5) to be delivered outside of the cooling device (1) when desired.

The present invention relates to a cooling device that comprises a hot and cold water dispenser.

Cold or hot water and ice requirements are provided by using the water dispensers located at the doors of particularly the wardrobe type and double door cooling devices, without opening the door. Usually water dispensers are used in cooling devices for supplying ice and cold water. In double door cooling devices the water dispenser is included in the door of the cooling compartment. In the present case, while the interior temperature of the cabin is sufficient for cooling water, an additional cooling process has to be implemented in order to produce ice. In wardrobe type cooling devices, the water dispenser is provided in the freezer compartment. Here while the ice is already present contrary to double door refrigerators, cold water is supplied from the water reservoir in the cooling compartment and transfused into the water dispenser by means of a pump.

When hot water is also desired to be obtained by using the water dispenser, problems arise in the manner of obtaining hot water and also conserving this water.

In the state of the art International Patent application no. WO2004092664, a refrigerator having a water dispenser supplying cold water, ice and hot water is described. In the said document, hot water is supplied by means of a heater. A thermal energy storage material is wrapped around the heater in order to enable the hot water to retain heat for a long period of time. Furthermore, a water tank insulated by insulation materials is used as the water reservoir.

The object of the present invention is to design a cooling device comprising a hot water dispenser wherein water is heated by using less energy.

The cooling device designed to fulfill the objective of the present invention, explicated in the first claim and the respective claims thereof, comprises a refrigerant conduit disposed inside or outside the water reservoir, situated between the compressor and the condenser, providing to heat the water by transferring the heat of the refrigerant leaving the compressor in superheated vapor phase to the water reservoir and/or the water in the water reservoir, without requiring the use of an additional heater.

The refrigerant conduit is configured helically such that the water reservoir is partially wrapped from the outside or to be in contact with the water in the water reservoir when disposed therein. Accordingly, the necessary increase of the surface area is provided so that heat transfer can be effective.

In another embodiment of the present invention, the walls of the water reservoir are clad by various insulation materials, for example vacuum insulated panels (VIP), so that the water reservoir is not affected by the cool environment inside the cooling cabin. Consequently, the water reservoir is provided not to be affected by the temperature of the cooling cabin and also the heated water therein not losing heat for a longer period of time.

In another embodiment of the present invention, the refrigerant conduit, after leaving the water reservoir, is passed from the frame surface wherein the door is in contact with the body, so that condensation does not occur on that surface. In this embodiment, the refrigerant leaving the water reservoir, transferring some of the heat it contains to the water reservoir, can be delivered onto the frame without requiring to be passed through the condenser in order to heat the frame and after being delivered to the frame, can pass on to the condenser to join in the refrigerant cycle. Since the temperature of the refrigerant leaving the compressor and delivered to the water reservoir is thus lowered, the high temperature refrigerant at the exit of the compressor can be conveniently used and sent with priority to the frame surface instead of the condenser. Also the structural hardships of sending the refrigerant to the condenser at the rear portion of the cooling device and then delivering again to the frame surface at the front are prevented.

In another embodiment of the present invention, the water reservoir is positioned on the wall of the compressor. In this position, the water in the water reservoir is also heated by the idle heat generated by the operation of the compressor.

By means of the present invention, the process of heating water is provided by the hot refrigerant leaving the compressor through transferring its heat to the water in the water reservoir without requiring the use of any other additional heaters. Furthermore, since the refrigerant conduit can be passed through the frame surface wherein the door is in contact with the body, the necessity of sending the refrigerant to the condenser at the rear of the cooling device and then delivering again to the frame surface in the front portion is eliminated.

The cooling device designed to fulfill the objective of the present invention is illustrated in the attached figured, where:

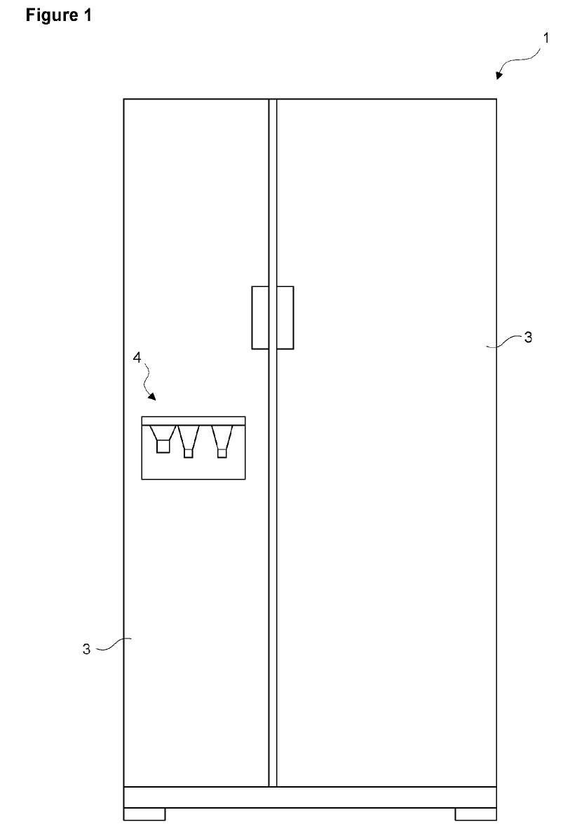

FIG. 1—is the schematic view of a cooling device.

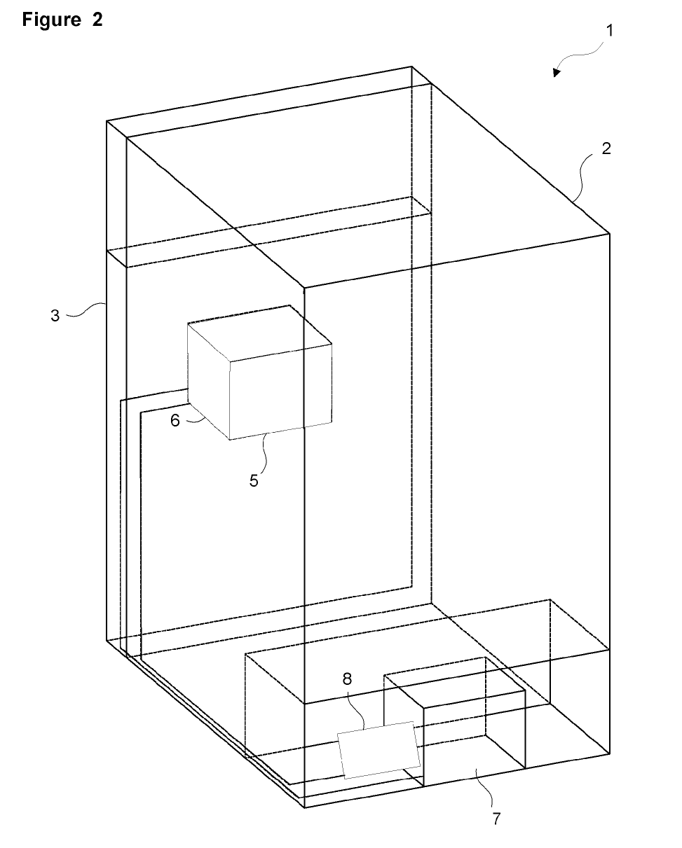

FIG. 2—is the schematic view of an embodiment of the present invention.

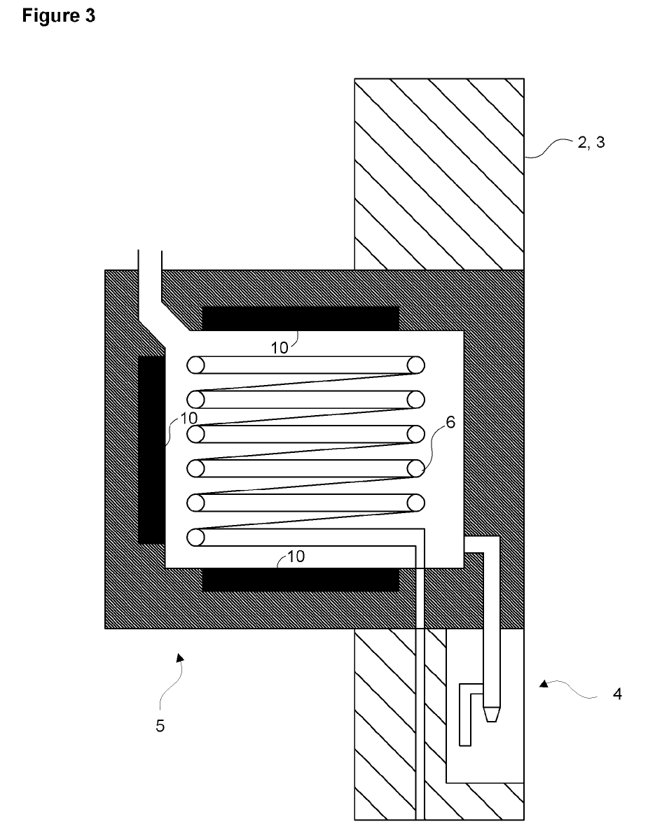

FIG. 3—is the schematic view of the water reservoir and the refrigerant conduit.

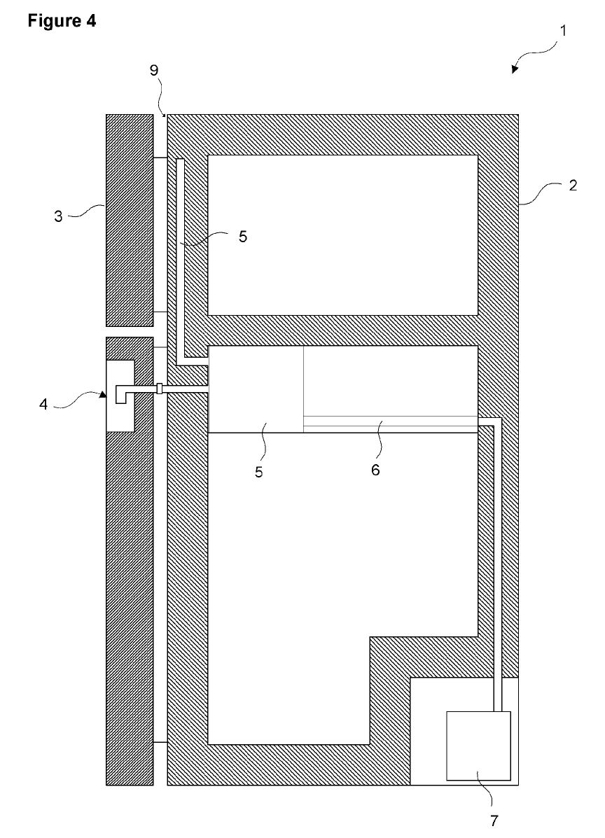

FIG. 4—is the schematic view of another embodiment of the present invention.

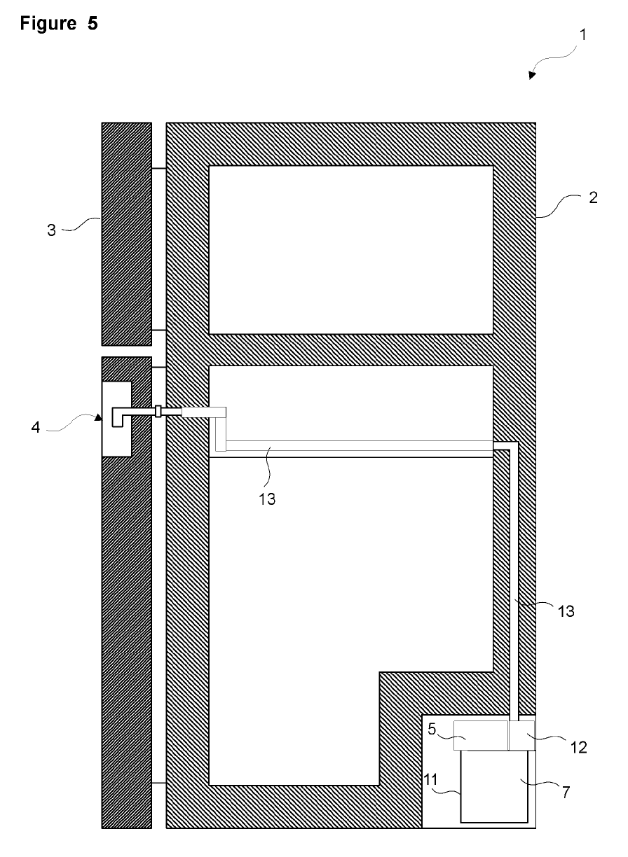

FIG. 5—is the schematic view of yet another embodiment of the present invention.

The elements illustrated in the figures are numbered as follows:
1. Cooling device
2. Cooling cabin
3. Door
4. Water dispenser
5. Water reservoir
6. Refrigerant conduit
7. Compressor
8. Condenser
9. Frame
10. Insulation panel
11. Compressor shell
12. Pump
13. Water transmittal duct

The cooling device (1) of the present invention comprises a cooling cabin (2) wherein items to be cooled are stored, one or more doors (3), preventing heat transfer between the cooling cabin (2) and the exterior environment when closed, providing access for the user to the cooling cabin (2) when opened, a compressor (7) providing the refrigerant to be sucked and pumped, a condenser (8) condensing the refrigerant leaving the compressor as superheated vapor to first liquid-vapor phase then to entirely liquid phase, one or more evaporators providing the circulating refrigerant within to absorb heat cooling the environment therein and a water reservoir (5) disposed on the door (3) or the cabin (2) wherein water is stored.

The cooling device (1) furthermore comprises a water dispenser (4) providing the water in the water reservoir (5) to be delivered outside of the cooling device (1) when desired and a refrigerant conduit (6)
situated between the compressor (7) and the condenser (8),
disposed inside or outside of the water reservoir (5),
transferring the heat of the refrigerant leaving the compressor (7) in superheated vapor phase to the water reservoir (5) and/or the water in the water reservoir (5) providing to be heated thereof (FIG. 1 and FIG. 2).

The refrigerant conduit (6) provides to convey the refrigerant from the compressor (7) to the condenser (8) by one end being connected to the compressor (7) and the other end to the condenser (8) and the portion thereof wrapped around the water reservoir (5) or emplaced into the water reservoir (5) having a helical structure to increase or enhance heat transfer (FIG. 3).

The hot refrigerant leaving the compressor (7) passing through the refrigerant conduit (6) reaches to the vicinity of the water reservoir (5) disposed in the cabin (2) or the door (3) and transfers the contained heat to the water in the water reservoir (5). The refrigerant transferring a portion of the heat it contains to the water reservoir (5) reaches the condenser (8) and joins the cooling cycle.

In another embodiment of the present invention, the cooling device (1) comprises insulation panels (10) that clad the water reservoir (5). Thus the water reservoir (5) is prevented from being affected by the temperature of the cabin (2) inside which it is disposed and also the heated water can preserve its heat for a longer time period (FIG. 3).

In another embodiment of the present invention, the cooling device (1) comprises a frame (9) through which the door (3) is in contact with the cooling cabin (2). After the refrigerant conduit (6) leaves the water reservoir (5) it passes through this surface so that condensation is prevented on the surface of the frame (9). The refrigerant conduit (6) passing through the inner surface of the frame (9) then goes to the condenser (8) and joins in the cooling cycle. Consequently, the problem of condensation on the frame (9) surface and respectively the adhesion of the gasket to the frame (9) are prevented.

In this embodiment, the refrigerant leaving the water reservoir (5) after transferring some of the contained heat, can be delivered unto the frame (9) for heating the frame (9) and after being delivered to the frame (9) passes to the condenser (8) joining in the cooling cycle. Consequently, since the temperature of the refrigerant is decreased through leaving the compressor (7) and reaching the water reservoir (5), it can be sent with priority unto the surface of the frame (9) instead of the condenser (8). Thus structural difficulties such as sending the refrigerant leaving the water reservoir (5) to the condenser (8) preferably disposed in the rear portion of the cooling device (1) then again delivering to the frame (9) surface at the front are prevented (FIG. 4).

In another embodiment of the present invention, the water reservoir (5) is disposed on the compressor shell (11) and the idle heat generated during the operation of the compressor (7) is used in heating the water in the water reservoir (5). In this embodiment, the cooling device (1) comprises a water transmittal duct (13) between the water reservoir (5) and the water dispenser (4) and a pump (12) that delivers the water heated in the water reservoir (5) to the water dispenser (4). The water heated in the water reservoir (5) is delivered up to the water dispenser (4) by means of a pump (12). The water reservoir (5) is disposed in the compressor (7) region outside of the cabin (2). The water reservoir (5) is seated on the compressor shell (11) and the contact surface is increased as much as possible in order to increase heat transfer by conduction (FIG. 5).

Consequently, the idle heat generated during the operation of the compressor (7) is used in heating the water in the water reservoir (5) and the use of an additional energy source is not required for heating the water.

By means of the present invention, water heating process is accomplished by transferring the heat of the hot refrigerant to the water in the water reservoir (5) without requiring the use of an additional heater. Furthermore, since the refrigerant conduit (6) can be passed through the frame (9) surface after leaving the water reservoir (5), the necessity of delivering the refrigerant to the condenser (8) disposed in the rear portion of the cooling device (1) then again delivering to the frame (9) surface at the front portion is eliminated.

1. A cooling device (1) comprising a cooling cabin (2) wherein items to be cooled are stored, one or more doors (3), preventing heat transfer between the cooling cabin (2) and the exterior environment when closed, providing access for the user to the cooling cabin (2) when opened, a compressor (7) providing the refrigerant to be sucked and pumped, a condenser (8) condensing the refrigerant leaving the compressor as superheated vapor to first liquid-vapor phase then to entirely liquid phase, one or more evaporators providing the circulating refrigerant within to absorb heat cooling the environment therein and a water reservoir (5) disposed on the door (3) or the cabin (2) wherein water is stored, and a water dispenser (4) providing the water in the water reservoir (5) to be delivered outside of the cooling device (1) when desired and characterized by a refrigerant conduit (6) that is • situated between the compressor (7) and the condenser (8), • disposed inside or outside of the water reservoir (5), • transferring the heat of the refrigerant in superheated vapor phase leaving the compressor (7) to the water reservoir (5) and/or the water in the water reservoir (5) providing to be heated thereof.

2. A cooling device (1) as in claim 1, characterized by a refrigerant conduit (6) with one end connected to the compressor (7) and the other end to the condenser (8) providing to convey the refrigerant from the compressor (7) to the condenser (8) and the portion thereof wrapping the water reservoir (5) or emplaced into the water reservoir (5) having a helical structure to increase or enhance heat transfer.

3. A cooling device (1) as in claim 1 or 2, comprising a frame (9) through which the door (3) is in contact with the cooling cabin (2) and characterized by a refrigerant conduit (6) that is passed from this surface after leaving the water reservoir (5) to prevent condensation on the frame (9) surface.

4. A cooling device (1) as in claim 1 or 2, characterized by insulation panels (10) cladding the water reservoir (5).
